(19) United States
(12) Patent Application Publication
(10) Pub. No.: US 2005/0006135 A1
(43) Pub. Date: Jan. 13, 2005

(54) Airtight cable and a manufacturing method of airtight cable

(75) Inventor: Masahiro Nakayama, Hamamatsu-shi (JP)

Correspondence Address: MCGINN & GIBB, PLLC, 8321 OLD COURTHOUSE ROAD, SUITE 200, VIENNA, VA, 22182-3817, US

(73) Assignee: Kurabe Industrial Co., Ltd., Hamamatsu-shi (JP)

(21) Appl. No.: 10/855,959

(22) Filed: May 28, 2004

(30) Foreign Application Priority Data
May 30, 2003 (JP) 2003-153647

(51) Int. Cl. H01B 5/08

(52) U.S. Cl. 174/128.1

(57) ABSTRACT

An airtight cable is comprising, stranded conductors in which an airtight part is at least partially formed in the elongating direction, and an insulation covering on the outer periphery thereof. The stranded conductors are essentially provided with conductor wires at the outermost layer and a thermoplastic polymer filler. The thermoplastic polymer, softened or melted by heating of the filler, is intruding into the space between the respective conductor wires at the airtight part of the stranded conductors.

### BACKGROUND OF THE INVENTION

1. Field of the Invention

The present invention relates to an airtight cable, which surely prevents oil and water from intruding into conductors by capillary phenomenon, and also from leaking out of cable terminal parts, and which provides facile terminal processing and good productivity at a lower cost.

2. Description of the Related Art

There has been provided cables used as lead wires for various machines and instruments, in which stranded conductors, made by stranding a plurality of conductor wires for the purpose of improving flexibility, are used as conductors. Generally, before such a type of cable is actually used, an insulation at each terminal part has been removed so that the stranded conductors may be exposed, and then an appropriate terminal processing corresponding to the using purpose is applied thereto. At that time, if there is any oil or water existing in the vicinity of the cable terminal parts, such oil and water would intrude, by capillary phenomenon, into the cable in the elongating direction through the inside of conductors, and would cause various troubles. These troubles would occur, in particular, when there is a difference in pressure between the terminals of the both ends of the cable, such as lead wires for automobile oxygen sensor, or lead wires used inside an oil case of automatic transmission for automobile.

Therefore, according to prior arts, for the purpose of preventing oil and water from leaking out of the cable terminal parts, for example, there has been provided a structure (as illustrated, e.g. in Patent Disclosure 1), characterized in that, a cable, in which exposed conductor parts have been formed, is positioned inside a cable holder case used for fixing the cable on an oil case, and also characterized in that, a thermosetting resin such as epoxy resin is filled in the space between respective exposed conductor wires of the cable.

Further, there has been provided a connector (as illustrated, e.g. in Patent Disclosure 2), characterized in that, a terminal holder plate, formed by welding and sealing of the space between respective terminal insertion holes of a substrate to which a plurality of terminals have been attached, is integrally formed with a cylindrical housing, and also characterized in that a sealant for preventing liquid leakage is attached to a cable introduction part of the cylindrical housing.

There has been also provided a cable (as illustrated, e.g. in Patent Disclosure 3), characterized in that, a bundle of thermoplastic resin fibers is placed at the space between respective conductor wires serving as stranded conductors, having an airtight part formed by heat and melting of that bundle of fibers.

Further, there has been provided a cable (as illustrated e.g. in Patent Disclosure 4), characterized in that, a water tight composition has been filled, by applying pressure thereto, in the space between respective wires serving as conductors.

However, the above discussed prior arts have several disadvantageous points. In the case of the structure as illustrated in Patent Disclosure 1, the thermosetting resin such as epoxy resin used as the filler, has poor compliance with thermal expansion or thermal shrinkage, and would cause crack easily, which might result in oil leakage. In order to cope with this problem, there has been also provided a cable holder case for oil leakage prevention which may use any resin material having good compliance and crack resistance (as illustrated, e.g. in Patent Disclosure 5). However, this type of cable holder case has very complicated and special form, and the production cost would become higher.

Similarly, in regard to the connector as illustrated in Patent Disclosure 2, likewise the case of cable holder case as illustrated in Patent Disclosure 5, the form thereof is very complicated and special, and the production cost would also become higher.

In regard to the structure as illustrated in Patent Disclosure 3, there has been a problem of poor terminal processability. If the strength of fibers., serving as the bundle of thermoplastic resin fibers, is insufficient, the bundle of fibers would be partially cut during stranding of conductor wires, whereby the cut fibers would go out of the stranded conductors, and the fibers would be melted and bonded with an insulation. Thus, it would become difficult to strip the insulation.

In regard to the structure as illustrated in Patent Disclosure 4, there has also been a problem of poor terminal processability, As the water tight composition at the space between the wires forming the conductors, and the composition on the outer periphery of the conductors, are connected to each other, when the insulation is stripped, the water tight composition would remain adhering to the surface of conductors. Consequently, during terminal assembly, preparation, the water tight composition would exist between the terminals and the conductors, would cause the defective conduction.

For the purpose of solving the problems of Patent Disclosures 1 through 5 as discussed above, the applicant of the present invention already provided an airtight cable (as illustrated in Patent Disclosure 6), characterized in that, conductor wires have been placed at an outermost layer of a filler comprising thermosetting polymer, and an airtight part has been formed, at least a part thereof, in the elongating direction, and the filler is intruding into the space between respective conductor wires in the airtight part.

Patent Disclosure 1: The official gazette of Examined Japanese Patent Publication No. Hei 1-59467.

Patent Disclosure 2: The official gazette of Japanese Patent No. 2825148.

Patent Disclosure 3: The official gazette of Unexamined Japanese Patent Publication No. 2000-243151.

Patent Disclosure 4: The official gazette of Unexamined Japanese Patent Publication No. Hei 10-204227.

Patent Disclosure 5: The official gazette of Japanese Patent No. 2766558.

Patent Disclosure 5: The official gazette of Unexamined Japanese Patent Publication No. 2002-175731.

### SUMMARY OF THE INVENTION

It is an object of the present invention to provide an airtight cable, which surely prevents oil and water from intruding into the cable by capillary phenomenon, and also from leaking out of cable terminal parts, and which provides facile terminal processing and good productivity at a lower cost.

To achieve the object mentioned above, according to claim 1 of the present invention, there is provided an airtight cable essentially provided with a plurality of conductor wires and a filler, comprising stranded conductors in which an airtight part has been formed, at least partially, in the elongating direction, and an insulation covering on an outer periphery of the stranded conductors, characterized in that the filler is composed, at least, of an airtight material comprising a thermoplastic polymer; the conductor wires are positioned at an outermost layer of the stranded conductors; and the airtight material serving as the filler is intruding into the space between respective conductor wires in the airtight part of the stranded conductors.

According to claim 2 of the present invention, there is provided an airtight cable essentially provided with a plurality of conductor wires and a filler, comprising stranded conductors in which an airtight part has been formed, at least partially, in the elongating direction, and an insulation covering on an outer periphery of the stranded conductors, characterized in that: the filler is composed, at least, of an airtight material, comprising a core material, and a thermoplastic polymer or a thermosetting polymer covering on an outer periphery of the core material; the conductor wires are positioned at an outermost layer of the stranded conductors; and the airtight material serving as the filler is intruding into the space between respective conductor wires in the airtight part of the stranded conductors.

According to claim 3 of the present invention, there is provided an airtight cable essentially provided with a plurality of conductor wires and a filler, comprising stranded conductors in which an airtight part has been formed, at least partially, in the elongating direction, and an insulation covering on an outer periphery of the stranded conductors, characterized in that: the filler is composed, at least, of an airtight material comprising a liquid swellable material; the conductor wires are positioned at an outermost layer of the stranded conductors; and the airtight material serving as the filler is intruding into the space between respective conductor wires in the airtight part of the stranded conductors.

According to claim 4 of the present invention, there is provided an airtight cable essentially provided with a plurality of conductor wires and a filler, comprising stranded conductors in which an airtight part has been formed, at least partially, in the elongating direction, and an insulation covering on an outer periphery of the stranded conductors, characterized in that: the filler is composed, at least, of an airtight material, comprising a core material, and a liquid swellable material covering on an outer periphery of the core material; the conductor wires are positioned at an outermost layer of the stranded conductors; and the airtight material serving as the filler is intruding into the space between respective conductor wires in the airtight part of the stranded conductors.

According to claim 5 of the present invention, there is provided the airtight cable as claimed in claim 3 or claim 4, further characterized in that the airtight material comprising the liquid swellable material, is at least comprising a liquid swellable polymer, or is at least comprising a liquid swellable polymer blended with a thermoplastic polymer or with a thermosetting polymer.

According to claim 6 of the present invention, there is provided the airtight cable as claimed in any one claim of claims 3 through 5, further characterized in that the swelling volume of the outer diameter of the filler, when the liquid swellable material absorbs liquid, is not less than 5% and not more than 15%.

According to claim 7 of the present invention, there is provided the airtight cable as claimed in any one claim of claims 3 through 6, further characterized in that a polyalkylene oxide resin is used as the liquid swellable polymer.

According to claim 8 of the present invention, there is provided the airtight cable as claimed in any one claim of claims 1 through 7, further characterized in that the conductor wires positioned at the outermost layer of the stranded conductors have been compressed in the radial direction so that the conductor wires may be in contact tightly with each other.

According to claim 9 of the present invention, there is provided a manufacturing method of airtight cable comprising steps of forming stranded conductors by stranding a plurality of conductor wires and a filler so that the conductor wires may be positioned at an outermost layer of the stranded conductors; and forming an airtight part, during extruding of and covering with an insulation, or after extruding of and covering with an insulation, on an outer periphery of said stranded conductors,

According to claim 10 of the present invention, there is provided the manufacturing method of airtight cable as claimed in claim 9, further comprising a step of forming the airtight part through heat processing of the filler by using heat generated during extruding of and covering with the insulation.

According to claim 11 of the present invention, there is provided the manufacturing method of airtight cable as claimed in claim 9, further comprising a step of forming the airtight part through heat processing of the filler by using heat generated during application of heat and cross-linking to the insulation.

According to claim 12 of the present invention, there is provided the manufacturing method of airtight cable as claimed in claim 9, further comprising a step of compressing the stranded conductors before extruding of and covering with the insulation on the outer periphery of the stranded conductors.

According to claim 13 of the present invention, there is provided the manufacturing method of airtight cable as claimed in claim 9, further comprising a step of using the filler by extruding of and covering with an airtight material on an outer periphery of a core material.

The essential material of the conductor wires, used for the airtight cable according to the present invention, are not limited, and any conductor material known as prior arts may be used, by considering the using condition (using purpose, required function, etc.) of the cable provided by the present invention.

As for the filler comprising the thermoplastic polymer used for the present invention may be, for example, a thermoplastic polymer formed in a shape of wire, fiber, powder or melted liquid. In the present invention, the thermoplastic polymer formed in a wire shape may preferably be used. This is because of the following reasons. In regard to the fiber shape of filler, if the strength of the fiber wires is insufficient, the strip feasibility of cable will be deteriorated when the fiber wires are cut. In regard to the powder shape of filler, the powder would grime a conductor stranding machine, or would cut the conductor wires by concentrated and hardened powders inside an extruding machine. In regard to the melted liquid filler, the liquid would also grime a conductor stranding machine, or would deteriorate the strip feasibility of cable by adhering the liquid filler to the insulation.

For the purpose of forming a wire shape of thermoplastic polymer, for example, the extruding method known as prior art may be used. When the extruding method is used, if the elongating processing is also applied at the same time, it is possible to expand the outer diameter of filler, by heat processing applied during forming of the airtight part on the stranded conductors. Thus, the filler comprising thermoplastic polymer may intrude inside the space between the respective conductor wires easily. The state in which the filler is intruding inside the space between the respective conductor wires would mean, where the space is provided between the respective conductor wires, that the thermoplastic polymer is existing in the space between the respective conductor wires, and where the conductor wires have been compressed in the radial direction so that the conductor wires may become in contact tightly with each other, that the thermoplastic polymer is existing in the state of being in tight contact with the inner peripheral surface of the conductor wires positioned in the circumferential direction.

There are various thermoplastic polymer known as prior arts, for example, polyolefin resin such as polyethylene, polypropylene, ethylene-vinyl acetate copolymer, ethylene-ethyl acrylate copolymer and ethylene-methyl methacrylate copolymer, and fluorocarbon polymer such as tetrafluoroethylene-hexafluoroethylene copolymer, tetrafluoroethylene-perfluoroalkoxyethylene copolymer, tetrafluoroethylene-ethylene copolymer, polyvinylidenefluoride, tetrafluoroethylene propylene rubber, tetrafluoroethylene-α-olefin copolymer, vinylidenefluoride-hexafluoropropylene copolymer, tetrafluoroethylene-hexafluoropropylene-vinylidenefluoride copolymer, polyperfluorobutenylvinylether, and fluorocarbon thermoplastic elastomer, and rubber material such as ethylene propylene rubber, and elastomer material such as olefin elastomer and styrene elastomer, and polyvinylchloride. They may be selected appropriately, by considering the using condition (using purpose, required function, etc.) of the cable provided by the present invention, or by considering the kind of insulation and the forming method of the airtight part (which will be discussed afterward). Further, it is also possible to combine several kinds of polymers, or to add any ingredient agent such as fire-retarding material, coloring agent, processing coadjuvant, antiaging agent, filling agent, etc., as long as such a combination or addition is appropriate.

The filler may also contain any expansion component. Accordingly, when the airtight part is formed on the stranded conductors, the filler comprising thermoplastic polymer may surely intrude into the space between the respective conductor wires. In particular, among thermoplastic polymers discussed as above, if the outer diameter expansion effect is insufficient, due to the characteristic of the polymer itself or due to the effect of any additive, it is desirable to contain the expansion component in such a polymer. For the purpose of containing the expansion component, for example, it is possible to generate foaming chemically, by mixing any foaming agent such as azodicarbonamide, azobisisobutyronitride, N,N′-dinitroso pentamethylene tetramine, P,P′-oxybis benzensulfonyl hydrazine, and P-toluene sulfonyl hydrazine, in the filler. The kind of expansion component and the volume of addition may be selected and adjusted appropriately, by considering the using condition (manufacturing temperature, using purpose, required function, etc.) of the cable provided by the present invention.

According to the present invention, the stranded conductors are formed by stranding the conductor wires with the filler comprising the thermoplastic polymer, so that the conductor wires are at least positioned at the outermost layer, and the respective conductor wires positioned at the outermost layer may preferably be compressed in the radial direction so that each conductor layer may become in tight contact with each other. When the airtight part is formed on the stranded conductors, there may be the case in which the filler is expanded too much, which would cause the expansion of the conductor wires comprising the stranded conductors in the circumferential direction of the cable, whereby the outer diameter of the stranded conductors would become larger than that of the original intention. However, because of the above structure of the present invention, it is possible to prevent the insulation from becoming relatively thin. Further, when forming the airtight part on the stranded conductors, it is also possible to prevent the softened or melted thermoplastic polymer, from going out of the space between the conductor wires, and from adhering to the insulation. Thus, the strip feasibility of the cable may not be deteriorated.

The airtight part serves to prevent oil and water from intruding into the inside of the cable by capillary phenomenon, and also to prevent oil and water which have intruded inside the cable from leaking out of the terminal parts of the cable. When the filler is heated and softened, or heated and melted, the airtight part is formed, at least partially (a part, or parts, or entire part), on the stranded conductors in the elongating direction. The airtight part may be formed on the stranded conductors at a part, or at several parts, or entirely, and this may be selected without any limitation, by considering the using condition (using purpose, required function, etc.) of the cable provided by the present invention.

There are several methods known as prior arts for forming of the airtight part, for example, in which the stranded conductors before extruding of and covering with the insulation are heated by any heating device, or in which the heat processing is applied by using the heat generated during extruding of and covering with the insulation, or in which the heat and cross-linking are applied to the insulation and the generated heat is used for heat processing, or in which the heat processing is applied during terminal processing of the cable. According to the present invention, the heat processing may preferably be used, by using the heat during extruding of and covering with the insulation, or by using the heat during application of heat and cross-linking to the insulation. This is because of the following reason. When the heat processing is applied before extruding of and covering with the insulation, if, for example, the filler contains any expansion component, the filer would expand too much, and the conductor wires comprising the stranded conductors would expand in the circumferential direction of the cable, whereby the outer diameter of the stranded conductors would become larger than that of original intention, and the insulation would become relatively thin. Further, the filler would go out of the space between the conductor wires and adhere to the insulation, whereby the strip feasibility of cable would become deteriorated. In addition, when the heat processing is applied during terminal processing of the cable, the facility and process for heating would be required apart from the ordinary terminal processing, which would result in poor productivity and higher cost.

The insulation is formed, by using any insulative covering material known as a prior art, through extruding thereof and covering on therewith on the stranded conductors, by using any extruder known as a prior art. If appropriate, the cross-linking may be applied according to the kind of insulative covering material. The kind of insulative covering material is not limited, and may be selected by considering the using condition (using purpose, required function, etc.) of the cable provided by the present invention.

According to claim 2 of the present invention, the filler used for the airtight cable has the structure that the airtight material covers the core material. The material of the core material is not limited as long as it may not be elongated too much by winding tension during processing, and it is possible to use, for example, any wire material made of metal such as copper, copper alloy, nickel, nickel alloy, aluminum, aluminum alloy, stainless steel or any one of those to which plating has been applied, or any fiber or extruded product made from organic material such as polyethylene, polypropylene, polyester, polyphenylenesulfide or aliphatic polyamide, aromatic polyamide, or any inorganic fiber such as glass fiber, carbon fiber or ceramic fiber. The core material may be used as a single material, or by stranding or arranging in a row, a plurality of core materials.

It is possible to use thermoplastic polymer or thermosetting polymer for the airtight material. When thermoplastic polymer is used, through softening or melting thereof by heating, the airtight material may intrude into the space between the respective conductor wires. When thermosetting polymer is used, due to the adhering function during hardening of the airtight material by heating, the airtight material may intrude into the space between the respective conductor, wires, and during the actual use, it is also possible to prevent the airtight material from being melted because of oil, chemical product or water. The state in which the airtight material is intruding inside the space between the respective conductor wires would mean, where the space is provided between the respective conductor wires, that the airtight material is existing in the space between the respective conductor wires, and where the conductor wires have been compressed in the radial direction so that the conductor wires may become in contact tightly with each other, that the airtight material is existing in the state of being in tight contact with the inner peripheral surface of the conductor wires positioned in the circumferential direction.

It is possible to use any thermoplastic polymer as discussed above. As for thermosetting polymer, it is possible to use, for example, rigid thermosetting polymer such as epoxy resin, phenol resin or melamine resin, or any soft thermosetting polymer hardened by cross-linking, containing cross-linking component in any soft polymer such as polyolefin resin, polyfluorocarbon rubber, silicone rubber, or ethylene-propylene rubber, used as cable insulation. When considering the compliance with heat expansion or heat shrinkage, and also the flexibility and processability, it is preferable to use any soft thermosetting polymer hardened by cross-linking. They may be selected appropriately, by considering the using condition (using purpose, required function, etc.) of the cable provided by the present invention, or by considering the kind of insulation and the forming method of the airtight part (which will be discussed afterward). Further, it is also possible to combine several kinds of polymers, or to add any ingredient agent such as fire-retarding material, coloring agent, processing coadjuvant, antiaging agent, filling agent, etc., as long as such a combination or addition is appropriate.

The airtight material may also contain any expansion component. Accordingly, when the airtight part is formed on the stranded conductors, the airtight material comprising thermoplastic polymer may surely intrude into the space between the respective conductor wires. For the purpose of containing the expansion component, for example, it is possible to generate foaming chemically, by mixing any foaming agent such as azodicarbonamide, azobisisobutyronitride, N,N′-dinitroso pentamethylene tetramine, P,P′-oxybis benzensulfonyl hydrazine, and P-toluene sulfonyl hydrazine, in the airtight material, The kind of expansion component and the volume of addition may be selected and adjusted appropriately, by considering the using condition (manufacturing temperature, using purpose, required function, etc.) of the cable provided by the present invention.

There are several methods of forming the filler by covering the core material with the airtight material, for example, in which the airtight material is extruded and covers the core material, or in which the airtight material in a shape of tape is wound around the core material, or in which the fiber shape of airtight material is placed on the core material by winding in the lateral direction or by braiding. As discussed above, the filler according to the present invention has a structure that the airtight material covers the core material, when the filler is formed, or if too much winding tension is applied when stranding the conductor wires with the filler, because of the existence of the core material, the filler may be prevented from being elongated or cut, whereby the unified outer diameter of the filler may be maintained. Consequently, the production speed may increase, whereby the productivity may also improve.

According to the present invention, the stranded conductors are formed by stranding the conductor wires with the filler in which the airtight material covers the core material, so that the conductor wires are at least positioned at the outermost layer, and the respective conductor wires positioned at the outermost layer may preferably be compressed in the radial direction so that each conductor layer may become in tight contact with each other. Accordingly, the airtight material is pressed by the conductor wires, and the airtight material will intrude into the space between the respective conductor wires, whereby the airtight performance may improve. Further, when forming the airtight part on the stranded conductors, it is also possible to prevent the airtight material from going out of the space between the conductor wires, and from adhering to the insulation. Thus, the strip feasibility of the cable may not be deteriorated.

The airtight part serves to prevent oil and water from intruding into the inside of the cable by capillary phenomenon, and also to prevent oil and water which have intruded inside the cable from leaking out of the terminal parts of the cable. When the filler is heated, the airtight part is formed, at least partially (a part, or parts, or entire part), on the stranded conductors in the elongating direction. The airtight part may be formed on the stranded conductors at a part, or at several parts, or entirely, and this may be selected without any limitation, by considering the using condition (using purpose, required function, etc.) of the cable provided by the present invention.

There are several methods known as prior arts for forming of the airtight part, for example, in which the stranded conductors before extruding of and covering with the insulation are heated by any heating device, or in which the heat processing is applied by using the heat generated during extruding of and covering with the insulation, or in which the heat and cross-linking are applied to the insulation and the generated heat is used for heat processing, or in which the heat processing is applied during terminal processing of the cable. According to the present invention, the heat processing may preferably be used, by using the heat during extruding of and covering with the insulation, or by using the heat during application of heat and cross-linking to the insulation, because it is not necessary to prepare any facility or process for heating separately, which may improve the productivity and reduce the cost.

The insulation is formed, by using any insulative covering material known as a prior art, through extruding thereof and covering on therewith on the stranded conductors, by using any extruder known as a prior art. If appropriate, the cross-linking may be applied according to the kind of insulative covering material. The kind of insulative covering material is not limited, and may be selected by considering the using condition (using purpose, required function, etc.) of the cable provided by the present invention.

According to claim 3 of the present invention, as to the filler used for the airtight cable, the filler is at least comprising the airtight material, and liquid swellable material is used for the airtight material. As for the liquid swellable material, it is possible to use liquid swellable polymer, or thermoplastic polymer or thermosetting polymer blended with liquid swellable polymer. With this structure, even if oil or water intrudes into the conductors, the liquid swellable polymer in contact with the oil or water, may absorb the oil or water and become swelled, whereby the outer diameter of the filler will increase. Accordingly, the intruding water and oil is absorbed in the airtight material, and due to the increased volume of the airtight material, the space into which the water and oil would intrude may be shut, whereby the further intrusion of the water and oil is prevented effectively.

The above function and effect may be presented significantly, when the thermoplastic polymer or thermosetting polymer serving as the airtight material has been shrunken because of deterioration by aging or heat, and the space is formed in the airtight material.

When thermoplastic polymer is used as the airtight material, through softening or melting thereof by heating, the airtight material may intrude into the space between the respective conductor wires. When thermosetting polymer is used, due to the adhering function during hardening of the airtight material by heating, the airtight material may intrude into the space between the respective conductor wires, and during the actual use, it is also possible to prevent the airtight material from being melted because of oil, chemical product or water.

The state in which the airtight material is intruding inside the space between the respective conductor wires would mean, where the space is provided between the respective conductor wires, that the airtight material is existing in the space between the respective conductor wires, and where the conductor wires have been compressed in the radial direction so that the conductor wires may become in contact tightly with each other, that the airtight material is existing in the state of being in tight contact with the inner peripheral surface of the conductor wires positioned in the circumferential direction,

It is possible to use any thermoplastic polymer or thermosetting polymer as discussed above. As for liquid swellable polymer, it is possible to use, for example, water swellable polymer which is swelled by absorbing water, or oil swellable polymer which is swelled by absorbing oil. As for water swellable polymer, it is possible to use any material having water swellability known as a prior art, such as polyvinylalcohol, polyacrylate salt, polyacrylamide, polyalkylene oxide, polyvinylacetate, polyamide, or polyurethane. In particular, polyalkylene oxide resin may preferably be used, because of having a good solving ability with thermoplastic polymer and thermosetting polymer, so that the airtight material may be swelled uniformly. As for oil swellable polymer, it is possible to use any material having oil swellability known as a prior art such as silicone rubber, ethylene-propylene rubber, silicone-modified ethylene-propylene rubber, chloroprene rubber, polyfluorocarbon rubber or poly norbornene resin.

It is preferable to set the blending value of the liquid swellable polymer, as the swelling volume of outer diameter (the outer diameter increase rate) of the filler, when any liquid is absorbed by the blended liquid swellable polymer, to be not less than 5% and not more than 15%. If the swelling volume is less than 5%, the outer diameter of the filler will not increase sufficiently, and when the space into which water or oil may intrude is wide, the space may not be shut sufficiently. On the other hand, if the swelling volume is more than 15%, the outer diameter of the filler will increase too much, whereby the airtight material would protrude out of the terminal part of the cable, or the shape of airtight cable would be distorted, or the insulation would be destroyed.

The airtight material may also contain any expansion component. Accordingly, when the airtight part is formed on the stranded conductors, the airtight material comprising thermoplastic polymer may surely intrude into the space between the respective conductor wires. For the purpose of containing the expansion component, for example, it is possible to generate foaming chemically, by mixing any foaming agent such as azodicarbonamide, azobisisobutyronitride, N,N′-dinitroso pentamethylene tetramine, P,P′-oxybis benzensulfonyl hydrazine, and P-toluene sulfonyl hydrazine, in the airtight material. The kind of expansion component and the volume of addition may be selected and adjusted appropriately, by considering the using condition (manufacturing temperature, using purpose, required function, etc.) of the cable provided by the present invention.

According to the present invention, the structure of the core material may be that the airtight material covers the core material. There are several methods of forming the filler by covering the core material with the airtight material, for example, in which the airtight material is extruded and covers the core material, or in which the airtight material in a shape of tape is wound around the core material, or in which the fiber shape of airtight material is placed on the core material by winding in the lateral direction or by braiding. Accordingly, when the filler is extruded to be in a shape of wire, or if too much winding tension is applied when stranding the conductor wires with the filler, the filler may be prevented from being elongated or cut, whereby the unified outer diameter of the filler may be maintained. Consequently, the production speed may increase, whereby the productivity may also improve. Further, when the airtight cable is manufactured by using the filler of which outer diameter is unified as discussed above, the filler will intrude into the space between the conductor wires uniformly in the elongating direction of the airtight cable, it is possible to increase the formed airtight part.

The material of the core material is not limited as long as it may not be elongated too much by winding tension during processing, and it is possible to use, for example, any wire material made of metal such as copper, copper alloy, nickel, nickel alloy, aluminum, aluminum alloy, stainless steel or any one of those to which plating has been applied, or any fiber or extruded product made from organic material such as polyethylene, polypropylene, polyester, polyphenylenesulfide or aliphatic polyamide, aromatic polyamide, or any inorganic fiber such as glass fiber, carbon fiber or ceramic fiber. The core material may be used as a single material, or by stranding or arranging in a row, a plurality of core materials.

According to the present invention, the stranded conductors are formed by stranding at least the conductor wires with the filler, so that the conductor wires are positioned at the outermost layer. At that time, it is preferable to arrange the position, so that the respective conductor wires at the outermost layer may become in contact with each other, and so that the inside of the conductor wires at the outermost layer and the outside thereof may not be connected to each other. With this structure, when the airtight part is formed on the stranded conductors, it is possible to prevent the airtight material going out of the space between the conductor wires, and thus from adhering to the insulation, Accordingly, it is possible to separate the material positioned inside the stranded conductors (airtight material) from the material positioned outside the stranded conductors (insulation), whereby the strip processing of the insulation may be facilitated, and the terminal processability may also improve because there is no airtight material remaining on the surface of the stranded conductors. Further, when the respective conductor wires positioned at the outermost layer have been compressed in the radial direction so that the conductor wires may become in tight contact with each other, the contact area of each respective conductor wire at the outermost layer will increase, therefore it is possible to surely prevent the airtight material from going out of the space between the conductor wires and thus from adhering to the insulation. Consequently, the terminal processability may further improve. In addition, by compressing the conductor wires, the airtight material will be pressed by the conductor wires, and the airtight material will intrude into the space between the respective conductor wires, whereby the airtight performance may improve.

The airtight part serves to prevent oil and water from intruding into the inside of the cable by capillary phenomenon, and also to prevent oil and water which have intruded inside the cable from leaking out of the terminal parts of the cable. When the filler is heated, the airtight part is formed, at least partially (a part, or parts, or entire part), on the stranded conductors in the elongating direction. The airtight part may be formed on the stranded conductors at a part, or at several parts, or entirely, and this may be selected without any limitation, by considering the using condition (using purpose, required function, etc.) of the cable provided by the present invention.

There are several methods known as prior arts for forming of the airtight part, for example, in which the stranded conductors before extruding of and covering with the insulation are heated by any heating device, or in which the heat processing is applied by using the heat generated during extruding of and covering with insulation, or in which the heat and cross-linking are applied to the insulation and the generated heat is used for heat processing, or in which the heat processing is applied during terminal processing of the cable. According to the present invention, the heat processing may preferably be used, by using the heat during extruding of and covering with the insulation, or by using the heat during application of heat and cross-linking to the insulation, because it is not necessary to prepare any facility or process for heating separately, which may improve the productivity and reduce the cost.

The insulation is formed, by using any insulative covering material known as a prior art, through extruding thereof and covering therewith on the stranded conductors, by using any extruder known as a prior art. At that time, it is necessary to form the insulation so that there is no space between the stranded conductors and the insulation, which would allow the intrusion of water or oil. The kind of insulative covering material is not limited, and may be selected by considering the using condition (using purpose, required function, etc.) of the cable provided by the present invention. If appropriate, the cross-linking may be applied thereto, according to the kind of insulation material.

Preferably, the insulation may cover the conductor wires directly, without any intermediate material such as liquid swellable polymer, for the purpose of facile terminal processing such as stripping. If the insulation covers the conductor wires together with any intermediate material, such an intermediate material would remain on the stranded conductors when stripping, whereby the terminal processability would be deteriorated.

As discussed above in detail, according to the airtight cable of the present invention, there is the airtight part formed by the filler, on the stranded conductors at least partially in the elongated direction, which is at least composed of the airtight material comprising thermoplastic polymer. Consequently, it is possible to surely prevent oil and water, from intruding into the inside of the cable by capillary phenomenon, and also from leaking out of the terminal part of the cable. This effect may be obtained stably even when the production speed is increased, whereby the productivity will improve remarkably. Thus, the airtight cable may be provided at a lower cost. Further, the airtight material will not go out of the space between the conductor wires, and hence will not adhere to the insulation. Therefore, the terminal processability will also be facilitated. Accordingly, the airtight cable according to the present invention may be used suitably for various purposes, such as for lead wires of automobile oxygen sensor, or for lead wires positioned inside an oil case of automatic transmission for automobile,

Further, according to the airtight cable of the present invention, there is the airtight part formed by the filler, on the stranded conductors at least partially in the elongated direction, which is at least composed, of the core material, and of the airtight material comprising thermoplastic polymer or thermosetting polymer covering the core material. Consequently, it is possible to surely prevent oil and water, from intruding into the inside of the cable by capillary phenomenon, and also from leaking out of the terminal part of the cable. This effect may be obtained stably even when the production speed is increased, whereby the productivity will improve remarkably. Thus, the airtight cable may be provided at a lower cost. Further, the airtight material will not go out of the space between the conductor wires, and hence will not adhere to the insulation. Therefore, the terminal processability will also be facilitated. Accordingly, the airtight cable according to the present invention may be used suitably for various purposes, such as for lead wires of automobile oxygen sensor, or for lead wires positioned inside an oil case of automatic transmission for automobile.

Further, according to the airtight cable of the present invention, there is the airtight part formed by the filler, on the stranded conductors at least partially in the elongated direction, which is at least composed of the airtight material comprising liquid swellable material. Consequently, it is further possible to surely prevent oil and water, from intruding into the inside of the cable by capillary phenomenon, and also from leaking out of the terminal part of the cable. Thus, the airtight cable may be provided at a lower cost. Further, the airtight material will not go out of the space between the conductor wires, and hence will not adhere to the insulation. Therefore, the terminal processability will also be facilitated. Accordingly, the airtight cable according to the present invention may be used suitably for various purposes, such as for lead wires of automobile oxygen sensor, or for lead wires positioned inside an oil case of automatic transmission for automobile.

### BRIEF DESCRIPTION OF THE DRAWINGS

The invention will be described below in detail with reference to the accompanying drawings, in which:

FIG. 1 is a perspective view of an airtight cable according to a first embodiment of the present invention, in which a part of the airtight cable has been exploded;

FIG. 2 is a side sectional of the airtight cable according to the first embodiment of the present invention;

FIG. 3 is a perspective view of an airtight cable according to the first embodiment of the present invention, in which a part of the airtight cable has been exploded;

FIG. 4 is a side sectional of the airtight cable as a comparative example;

FIG. 5 is a perspective view of an airtight cable according to a second embodiment of the present invention, in which a part of the airtight cable has been exploded;

FIG. 6 is a side sectional of the airtight cable according to the second embodiment of the present invention;

FIG. 7 is a perspective view of an airtight cable according to a third embodiment of the present invention, in which a part of the airtight cable has been exploded;

FIG. 8 is a side sectional of the airtight cable according to the third embodiment of the present invention;

FIG. 9 is a perspective view of an airtight cable according to the third embodiment of the present invention, in which a part of the airtight cable has been exploded; and

FIG. 10 is a side sectional of the airtight cable according to the third embodiment of the present invention.

### DETAILED DESCRIPTION OF THE INVENTION

### First Embodiment

A first embodiment of the present invention will now be described with reference to examples 1-1 through 1-4, together with a comparative example.

### EXAMPLES 1-1 THROUGH 1-4

Stranded conductors, of which finished outer diameter was 1.05 mm, were formed by stranding eleven tinned annealed copper conductors of which respective wire diameter was 0.26 mm, with a filler comprising polyethylene compound of which diameter was 0.5 mm, at a pitch of 8.2 mm. Then, an insulation comprising polyfluorocarbon rubber having the thickness of 0.4 mm was extruded and covered the stranded conductors at 130° C., simultaneously with cross-linking thereof by continuous cross-linking method, using pressurized steam at 200° C., and eventually, a cable of which finished outer diameter was 2.1 mm, was produced.

The airtight part was formed, by using heat and pressure generated during cross-linking of the insulation, through simultaneous melting and expansion of the filler comprising polyethylene compound. Whether or not compression was applied to the stranded conductors, and whether or not an expansion component (azodicarbonamide foaming agent, of which resolution temperature was at 165° C.) was included in the filler, were indicated in Table 1.

### EXAMPLE 1-5

The same material and same method as those of examples 1-1 through 1-4 were used for producing this example, other than the forming of airtight part. The airtight part was formed by introducing the stranded conductors, before extruding of and covering with the insulation, into a conductor heater at 200° C.

For reference, the compression was not applied to the stranded conductors, and the expansion component was not included in the filler.

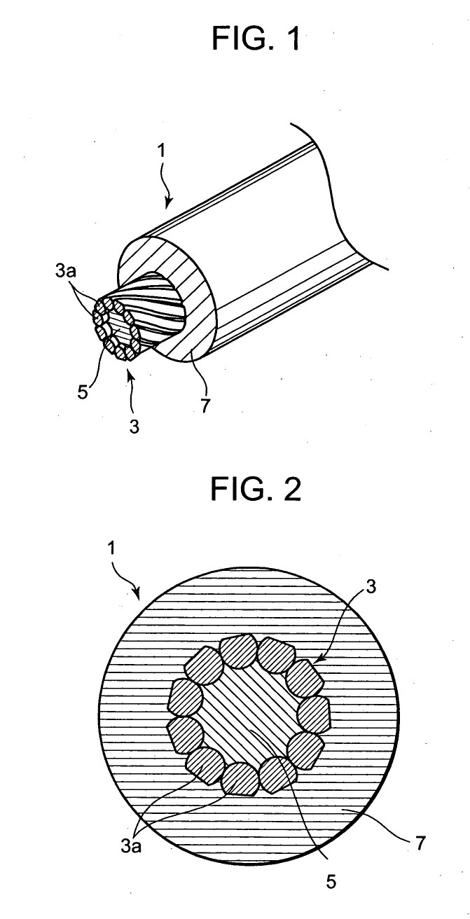

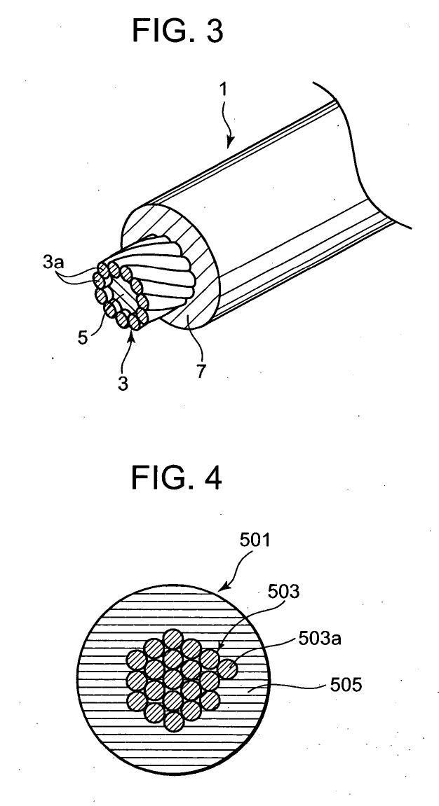

FIGS. 1 and 2 are views of an airtight cable 1 produced by the above method. Reference numeral 3 shows stranded conductors, reference numeral 3a shows conductor wires serving as the stranded conductors 3, reference numeral 5 shows an airtight part (a filler), and reference numeral 7 shows an insulation. With reference to FIGS. 1 and 2, the compression had been applied to the stranded conductors 3, whereby an outermost surface of the respective conductor wires 3a was compressed into a flat shape. On the other hand, FIG. 3 illustrates another type of airtight cable 1, to which the above compression had not been applied. According to FIG. 3, the outermost surface of the respective conductor wires 3a was not compressed.

### COMPARATIVE EXAMPLE 1-1

Stranded conductors, of which finished outer diameter was 0.9 mm, were formed by stranding twenty tinned annealed copper conductors of which respective wire diameter was 0.18 mm, at a pitch of 35 mm. Then, an insulation comprising polyfluorocarbon rubber having the thickness of 0.4 mm was extruded and covered the stranded conductors at 130° C., simultaneously with cross-linking thereof by continuous cross-linking method, using pressurized steam at 200° C., and eventually, a cable of which finished outer diameter was 1.7 mm, was produced. The compression was not applied to the stranded conductors, and the expansion component was not used.

FIG. 4 is a sectional view of an airtight cable 501 produced by this comparative method. Reference numeral 503 shows stranded conductors, reference numeral 503a shows conductor wires serving as the stranded conductors 503, and reference numeral 505 shows an insulation.

By using the above six types of cables as examples, the test for airtight performance, oil leakage and terminal processability was conducted. The assessment (scoring) method is described as follows. The results are shown in Table 1.

(Airtight Performance)

Air pressure at 0.049 MPa was applied to a terminal end of each example, which had been cut at length of 200 mm. The amount of air leaking out of the other terminal end of each example (air leakage amount) was measured for 10 minutes.

(Oil Leakage)

A terminal end of each example, which had been cut at length of 500 mm, was dipped in oil, and pressure at 0.196 MPa was applied to the oil surface. The amount of oil leaking out of the other terminal end of each example (oil leakage amount) was measured for 24 hours. As for the test oil, Nissan Matic Fluid D was used.

(Terminal Processability)

As for each of the examples of the present embodiment, a part of the insulation at which the airtight part had been formed, was stripped at width of 20 mm, and the adhering state of the filler and insulative covering material, remaining on the surface of the stranded conductors, was checked by visual inspection. As for the comparative example, the insulation at an arbitrary position in the elongating direction was stripped at width of 20 mm, and the adhering state of the insulative covering material, remaining on the surface of the stranded conductors, was checked by visual inspection.

When there was no insulative covering material adhering to any of the examples, the score was ⊚. When there was any insulative covering material adhering to examples, if the adhering amount was so small and would not cause any problem for actual use, the score was ◯. And when there was any insulative covering material adhering to examples, which caused problem for actual use, the score was X.

[Table 1]

As a result, although there was an air leakage and oil leakage detected as to the cable of the comparative example 1-1, each example of the cable according to the present invention proved to be sufficient for actual use as for air leakage and oil leakage. By comparing the example 1-1 with the example 1-2, and also the example 1-3 with the example 1-4, it was proven that the airtight performance and terminal processability would improve, when the conductor wires positioned at the outermost layer had been compressed in the radial direction to be in tight contact with each other. Further, by comparing the example 1-1 with the example 1-2, and also by comparing the example 1-3 with the example 1-4, it was also proven that the airtight performance and oil leakage resistance would improve, when the expansion component (foaming agent) had been included in the filler. When the example 1-4 was compared with the example 1-5, the airtight performance, the oil leakage resistance, the state of adhering resin remaining on the conductor surface, were substantially equivalent, but as for the strip feasibility, the example 1-4 proved to be better than the example 1-5. Therefore, it was found that the forming of airtight part should preferably be done in a state of being covered with the insulation.

### Second Embodiment

A second embodiment of the present invention will now be described with reference to several drawings, together with comparative examples.

### EXAMPLES 2-1 AND 2-2

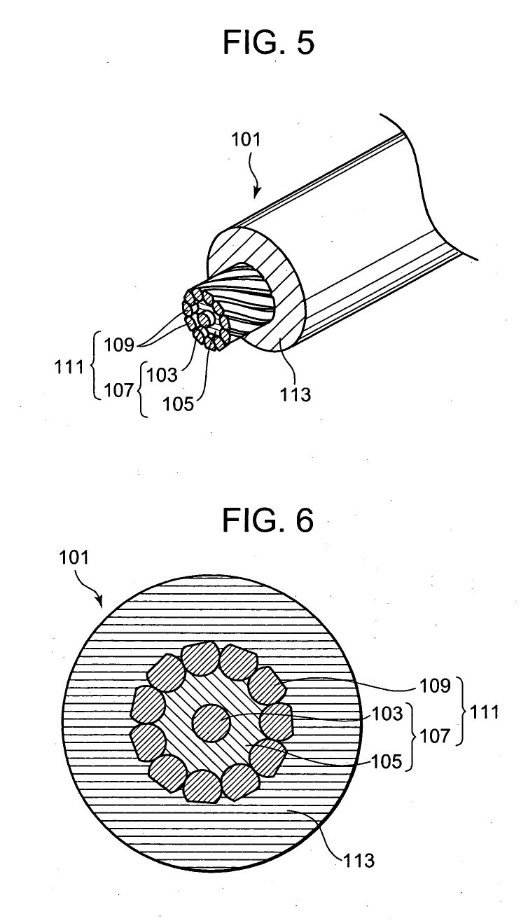

An airtight cable 101 according to the second embodiment of the present invention is as per shown in FIGS. 5 and 6. There was a core material 103 comprising tinned annealed copper conductor of which diameter was 0.26 mm. An airtight material 105 comprising polyethylene compound (thermoplastic polymer) was extruded and covered the core material 103, so that the outer diameter of the airtight material 105 became 0.65 mm, which served as a filler 107. Then, stranded conductors 111, of which finished outer diameter was 1.05 mm, were formed by stranding eleven conductor wires 109, comprising tinned annealed copper conductors of which respective wire diameter was 0.26 mm, with the filler 107, at a pitch of 8.2 mm, so that the conductor wires 109 were positioned at an outermost layer of the stranded conductors 111. Then, an insulation 113, comprising polyethylene compound having the thickness of 0.3 mm, was extruded and covered the stranded conductors 111 at 130° C., simultaneously with cross-linking thereof by continuous cross-linking method, using pressurized steam at 200° C., and eventually, the airtight cable 101, of which finished outer diameter was 1.7 mm, was produced.

The airtight part was formed, by using heat and pressure generated during cross-linking of the insulation 113, through melting of the airtight material 105 comprising polyethylene compound. Whether or not compression was applied to the stranded conductors 111, was indicated in Table 2.

With reference to FIGS. 5 and 6, the compression had been applied to the stranded conductors 111, whereby an outermost surface of the respective conductor wires 109 was compressed into a flat shape. On the other hand, if the compression had not been applied, the outermost surface of the respective conductor wires 109 was not compressed.

### EXAMPLES 2-3 AND 2-4

The same material and same method as those of example 2-1 were used for producing these examples, except for using polyfluorocarbon rubber (soft thermosetting polymer) as the airtight material 105, and also for using polyfluorocarbon rubber as the insulation 113.

The airtight part was formed by hardening the airtight material 105 comprising polyfluorocarbon rubber, using heat and pressure generated during cross-linking of the insulation 113. Whether or not compression was applied to the stranded conductors 111, was indicated in Table 2.

### COMPARATIVE EXAMPLES 2-1 THROUGH 2-4

For the purpose of comparing with the examples 2-1 through 2-4, comparative examples 2-1 through 2-4 were provided by not using the core material 103.

### COMPARATIVE EXAMPLE 2-5

Stranded conductors, of which finished outer diameter was 0.9 mm, were formed by stranding twenty tinned annealed copper conductors of which respective wire diameter was 0.18 mm, at a pitch of 35 mm. Then, an insulation comprising polyfluorocarbon rubber having the thickness of 0.4 mm was extruded and covered the stranded conductors at 130° C., simultaneously with cross-linking thereof by continuous cross-linking method, using pressurized steam at 200° C., and eventually, a cable of which finished outer diameter was 1.7 mm, was produced. The compression was not applied to the stranded conductors, and the expansion component was not used

By using the above nine types of cables (providing 5 samples per type) as examples, the test for airtight performance, oil leakage, terminal processability and productivity was conducted. The assessment (scoring) method is described as follows. The results are shown in Table 2.

(Airtight Performance)

Air pressure at 0.049 MPa was applied to a terminal end of each example, which had been cut at length of 200 mm. The average amount of air leaking out of the other terminal end of five examples (air leakage amount) was measured for 10 minutes.

(Oil Leakage)

A terminal end of each example, which had been cut at length of 500 mm, was dipped in oil, and pressure at 0.196 MPa was applied to the oil surface. The average amount of oil leaking out of the other terminal end of five examples (oil leakage amount) was measured for 24 hours. As for the test oil, Nissan Matic Fluid D was used.

(Terminal Processability)

As for each of examples 2-1 through 2-4 of the present embodiment, and as for each of comparative examples 2-1 through 2-4, a part of the insulation at which the airtight part had been formed, was stripped at width of 20 mm, and the adhering state of the filler and insulative covering material, remaining on the surface of the stranded conductors, was checked by visual inspection. As for the comparative example 2-5, the insulation at an arbitrary position in the elongating direction was stripped at width of 20 mm, and the adhering state of the insulative covering on material, remaining on the surface of the stranded conductors, was checked by visual inspection.

When there was no insulative covering material adhering to any of the examples, the score was ⊚. When there was any insulative covering material adhering to examples, if the adhering amount was so small and would not cause any problem for actual use, the score was ◯. And when there was any insulative covering on material adhering to examples, which caused problem for actual use, the score was X.

(Productivity)

The line speed, during forming of the filler by extruding of and covering with the airtight material on the core material, was measured. The line speed was set so that the outer diameter of the filler became unified.

[Table 2]

As a result, the following points were proven. First, there was an air leakage and oil leakage detected as to the cable of the comparative example 2-5. Further, as for the examples 2-1 through 2-4 and the comparative examples 2-1 through 2-4, although each example of the cable proved to be sufficient for actual use as for air leakage and oil leakage, when comparing from the viewpoint of whether or not the core material was provided, the examples 2-1 through 2-4 having the core material presented smaller amount of air leakage and oil leakage. In addition, as compared with the examples 2-1 through 2-4 having the core material, the line speed of the comparative examples 2-1 through 2-4, having no core material, was considerably low, and the productivity was poor.

By comparing the example 2-1 with the example 2-2, and also the example 2-3 with the example 2-4, it was proven that the airtight performance and terminal processability would improve, when the conductor wires positioned at the outermost layer had been compressed in the radial direction to be in tight contact with each other.

Apart from the above test, in regard to the comparative examples 2-1 through 2-4, when the filler was formed at the same cable speed as that of the examples 2-1 through 2-4, the filler was extruded, and it was impossible to form the filler at a uniform outer diameter.

### Third Embodiment

A third embodiment of the present invention will now be described with reference to drawings 7 through 10, together with comparative examples.

### EXAMPLES 3-1 THROUGH 3-6

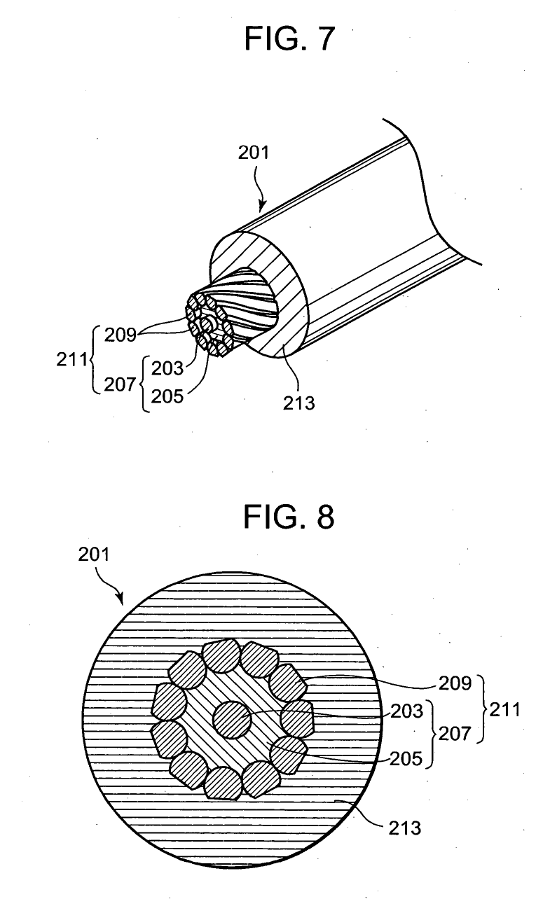

An airtight cable 201 according to these examples is as per shown in FIGS. 7 and 8. There was a core material 203 comprising tinned annealed copper conductor of which diameter was 0.26 mm. An airtight material 205 was extruded and covered the core material 203, so that the outer diameter of the airtight material 205 became 0.65 mm, which served as a filler 207. As for the airtight material 205, polyalkylene oxide resin (AQUA-CALK TW, manufactured by Sumitomo Seika Chemicals Company Limited), serving as liquid swellable polymer (water swellable polymer), was mixed with polyethylene compound serving as thermoplastic polymer, and the obtained material was used. Then, stranded conductors 211, of which finished outer diameter was 1.05 mm, were formed by stranding eleven conductor wires 209, comprising tinned annealed copper conductors of which respective wire diameter was 0.26 mm, with the filler 207, at a pitch of 8.2 mm, so that the conductor wires 209 were positioned at an outermost layer of the stranded conductors 211. Then, an insulation 213, comprising polyethylene compound having the thickness of 0.3 mm, was extruded and covered the stranded conductors 211 at 130° C., simultaneously with cross-linking thereof by continuous cross-linking method, using pressurized steam at 200° C., and eventually, the airtight cable 201, of which finished outer diameter was 1.7 mm, was produced.

The airtight part was formed, by using heat and pressure generated during cross-linking of the insulation 213, through melting of the airtight material 205 comprising polyethylene compound. Whether or not compression was applied to the stranded conductors 211, and the swelling volume of the outer diameter of the filler 207 (outer diameter increase rate), were indicated in Table 3.

As to whether or not the compression was applied to the stranded conductors 211, the examples were substantially the same as those of the first and second embodiment as discussed above.

### EXAMPLES 3-7 AND 3-8

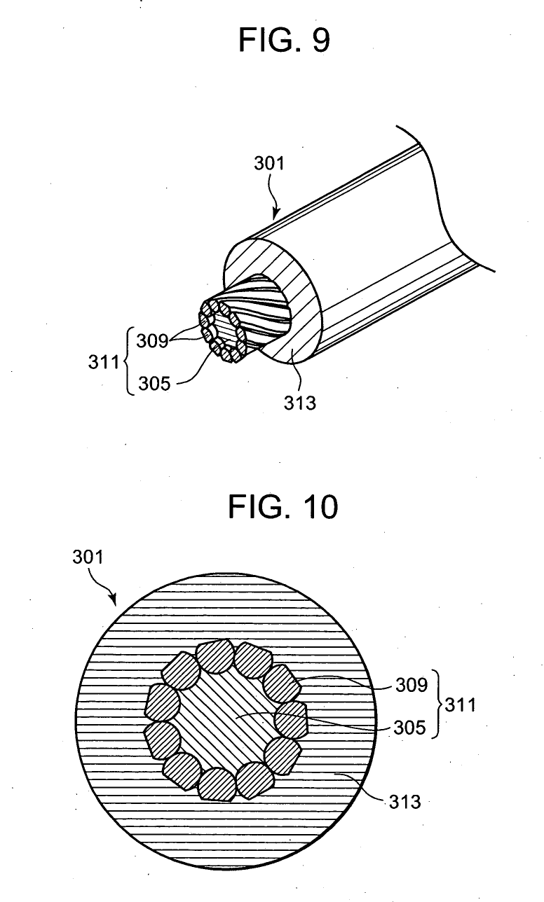

An airtight cable 301 according to these examples is as per shown in FIGS. 9 and 10. An airtight material was extruded, so that the outer diameter of the airtight material became 0.65 mm, which served as a filler 305. As for the airtight material, polyalkylene oxide resin (AQUA-CALK TW, manufactured by Sumitomo Seika Chemicals Company Limited), serving as liquid swellable polymer (water swellable polymer), was mixed with polyethylene compound serving as thermoplastic polymer, and the obtained material was used. Then, stranded conductors 311, of which finished outer diameter was 1.05 mm, were formed by stranding eleven conductor wires 309, comprising tinned annealed copper conductors of which respective wire diameter was 0.26 mm, with the filler 305, at a pitch of 8.2 mm, so that the conductor wires 309 were positioned at an outermost layer of the stranded conductors 311. Then, an insulation 313, comprising polyethylene compound having the thickness of 0.3 mm, was extruded and covered the stranded conductors 311 at 130° C., simultaneously with cross-linking thereof by continuous cross-linking method, using pressurized steam at 200° C., and eventually, the airtight cable 301, of which finished outer diameter was 1.7 mm, was produced.

The airtight part was formed, by using heat and pressure generated during cross-linking of the insulation 313, through melting of the airtight material 305 comprising polyethylene compound. Whether or not compression was applied to the stranded conductors 311, and the swelling volume of the outer diameter of the filler 307 (outer diameter increase rate), were indicated in Table 3.

### EXAMPLE 3-9

An airtight cable 201 according to this example is as per shown in FIGS. 7 and 8. There was a core material 203 comprising tinned annealed copper conductor of which diameter was 0.26 mm. An airtight material 205 was extruded and covered the core material 203, so that the outer diameter of the airtight material 205 became 0.65 mm, which served as a filler 207. As for the airtight material 205, polyalkylene oxide resin AQUA-CALK TW, manufactured by Sumitomo Seika Chemicals Company Limited), serving as liquid swellable polymer (water swellable polymer), was mixed with oil swellable polyfluorocarbon rubber compound serving as liquid swellable polymer (oil swellable polymer), and the obtained material was used. Then, stranded conductors 211, of which finished outer diameter was 1.05 mm, were formed by stranding eleven conductor wires 209, comprising tinned annealed copper conductors of which respective wire diameter was 0.26 mm, with the filler 207, at a pitch of 8.2 mm, so that the conductor wires 209 were positioned at an outermost layer of the stranded conductors 211. Then, an insulation 213, comprising polyfluorocarbon rubber compound having the thickness of 0.4 mm, was extruded and covered the stranded conductors 211 at 130° C. simultaneously with cross-linking thereof by continuous cross-linking method, using pressurized steam at 200° C., and eventually, the airtight cable 201, of which finished outer diameter was 1.7 mm, was produced.

The airtight part was formed, by using heat and pressure generated during cross-linking of the insulation 213, through adhering power during hardening of the airtight material 205 comprising oil swellable polyfluorocarbon rubber compound. Whether or not compression was applied to the stranded conductors 211, and the swelling volume of the outer diameter of the filler 207 (outer diameter increase rate), were indicated in Table 4.

### EXAMPLE 3-10

An airtight cable 301 according to this example is as per shown in FIGS. 9 and 10. An airtight material was extruded, so that the outer diameter of the airtight material became 0.65 mm, which served as a filler 305. As for the airtight material, polyalkylene oxide resin (AQUA-CALK TW, manufactured by Sumitomo Seika Chemicals Company Limited), serving as liquid swellable polymer (water swellable polymer), was mixed with oil swellable polyfluorocarbon rubber compound serving as liquid swellable polymer (oil swellable polymer), and the obtained material was used. Then, stranded conductors 311, of which finished outer diameter was 1.05 mm, were formed by stranding eleven conductor wires 309, comprising tinned annealed copper conductors of which respective wire diameter was 0.26 mm, with the filler 307, at a pitch of 8.2 mm, so that the conductor wires 309 were positioned at an outermost layer of the stranded conductors 311. Then, an insulation 313, comprising polyfluorocarbon rubber compound having the thickness of 0.4 mm, was extruded and covered the stranded conductors 311 at 130° C., simultaneously with cross-linking thereof by continuous cross-linking method, using pressurized steam at 200° C., and eventually, the airtight cable 301, of which finished outer diameter was 1.7 mm, was produced.

The airtight part was formed, by using heat and pressure generated during cross-linking of the insulation 313, through adhering power during hardening of the airtight material 305 comprising oil swellable polyfluorocarbon rubber compound. Whether or not compression was applied to the stranded conductors 311, and the swelling volume of the outer diameter of the filler 307 (outer diameter increase rate) comprising the airtight material 305, were indicated in Table 4.

### EXAMPLES 3-11 AND 3-12

As for the example 3-9, another example without having polyalkylene oxide resin, was provided as an example 3-11. And as for the example 3-10, another example without having polyalkylene oxide resin, was provided as an example 3-12.

### EXAMPLES 3-13 AND 3-14

As for the example 3-11, another example in which oil swellable polyethylene compound was used instead of oil swellable polyfluorocarbon rubber compound, and in which the airtight part had been formed by melting an airtight material comprising oil swellable polyethylene compound, was provided as an example 3-13. Further, as for the example 3-12, another example in which oil swellable polyethylene compound was used instead of oil swellable polyfluorocarbon rubber compound, and in which the airtight part had been formed by melting an airtight material comprising oil swellable polyethylene compound was provided as an example 3-14.

### COMPARATIVE EXAMPLES 3-1 THROUGH 3-4

As for the example 3-1, a comparative example 3-1 without having polyalkylene oxide resin, was provided. As for the example 3-6, a comparative example 3-2 without having polyalkylene oxide resin, was provided. As for the example 3-7, a comparative example 3-3 without having polyalkylene oxide resin, was provided. And as for the example 3-8, a comparative example 3-4 without having polyalkylene oxide resin, was provided.

### COMPARATIVE EXAMPLE 3-5

Stranded conductors, of which finished outer diameter was 0.9 mm, were formed by stranding twenty tinned annealed copper conductors of which respective wire diameter was 0.18 mm, at a pitch of 35 mm. Then, an insulation comprising polyfluorocarbon rubber having the thickness of 0.4 mm was extruded and covered the stranded conductors at 130° C., simultaneously with cross-linking thereof by continuous cross-linking method, using pressurized steam at 200° C., and eventually, a cable of which finished outer diameter was 1.7 mm, was produced.

The compression was not applied to the stranded conductors, and the expansion component was not used.

By using the above nineteen types of cables (providing 5 samples per type) as examples, the test for airtight performance, water leakage, terminal processability and productivity was conducted. In addition, as for the examples 3-9 through 3-14, the oil leakage test was also conducted. The assessment (scoring) method is described as follows. The results of the examples are shown in Tables 3 and 4, and the results of the comparative examples are shown in Table 5.

(Water Leakage)

A terminal end of each example, which had been cut at length of 200 mm, was dipped in water, and pressure at 0.049 MPa was applied to the water surface. The average amount of water leaking out of the other terminal end of five examples (water leakage amount) was measured for 100 hours.

(Airtight Performance)

After the water leakage test was finished, the same examples were used for airtight performance test, by applying air pressure at 0,098 MPa to a terminal end of each example. The average amount of air leaking out of the other terminal end of five examples (air leakage amount) was measured for 10 minutes.

(Oil Leakage)

A terminal end of each example, which had been cut at length of 500 mm, was dipped in oil, and pressure at 0.196 MPa was applied to the oil surface. The average amount of oil leaking out of the other terminal end of five examples (oil leakage amount) was measured for 24 hours, As for the test oil, Nissan Matic Fluid D was used.

(Terminal Processability)

As for each of examples 3-1 through 3-8 of the present embodiment, and as for each of comparative examples 3-1 through 3-4, a part of the insulation at which the airtight part had been formed, was stripped at width of 20 mm, and the adhering state of the filler and insulative covering material, remaining on the surface of the stranded conductors, was checked by visual inspection. As for the comparative example 3-5, the insulation at an arbitrary position in the elongating direction was stripped at width of 20 mm, and the adhering state of the insulative covering material, remaining on the surface of the stranded conductors, was checked by visual inspection.

When there was no insulative covering material adhering to any of five examples, the score was ⊚. When there was any insulative covering material adhering to examples, if the adhering amount was so small and would not cause any problem for actual use, the score was ◯. And when there was any insulative covering material adhering to examples, which caused problem for actual use, the score was X.

(Productivity)

The line speed, during forming of the filler by extruding of and covering with the airtight material on the core material, was measured. The line speed was set so that the outer diameter of the filler became unified.

[Table 3]

[Table 4]

[Table 5]

As a result, the following points were proven. First, there was a water leakage and air leakage detected as to the cable of the comparative example 3-5. Further, as for the comparative examples 3-1 through 3-4, although each comparative example of the cable proved to be sufficient for actual use as for water leakage and air leakage, when compared with the examples 3-1 through 3-10, the examples 3-1 through 8-10 having polyalkylene oxide resin as liquid swellable polymer presented smaller amount of water leakage and air leakage.

As for the examples 3-9 and 3-10, in which, oil swellable polyfluorocarbon rubber compound serving as liquid swellable polymer, was mixed with polyalkylene oxide resin serving as liquid swellable polymer, the oil leakage amount was also small.

Further, the examples 3-11 and 3-12, having the airtight material comprising oil swellable polyfluorocarbon rubber compound serving as liquid swellable polymer, and examples 3-13 and 3-14, having the airtight material comprising oil swellable polyethylene compound, also presented smaller amount of oil leakage and air leakage, and showed good characteristic as that of examples 3-1 through 3-10 having polyalkylene oxide resin serving as liquid swellable polymer.

When the examples 3-1 through 3-5 were compared, it was proven that, the examples 3-2 through 3-4, having preferable swelling volume (outer diameter increase rate) according to the present invention, especially presented very good water leakage resistance and airtight performance.

For reference, as for the example 3-5, although it will not cause any bad effect to actual use, there was a slight amount of extrusion of the airtight material out of a terminal of the cable.

By comparing the example 3-3 with the example 3-6, and also by comparing the example 3-7 with the example 3-8, it was proven that, the airtight performance and terminal processability would improve, when the conductor wires positioned at the outermost layer had been compressed in the radial direction to be in tight contact with each other.

Further, by comparing, the example 3-3 with the example 3-7, the example 3-6 with the example 3-8, the example 3-9 with the example 3-10, the example 3-11 With the example 3-12, and the example 3-13 with the example 3-14. it was also proven that the line speed could be increased when the core material was provided, and that the productivity would improve.

TABLE 1

| | Example | Example | Example | Example | Example | Comparative |
|---|---|---|---|---|---|---|
| | 1-1 | 1-2 | 1-3 | 1-4 | 1-5 | example 1-1 |
| Conductor wires | TA 11/0.26, with center filler | | | | | TA20/0.18 |
| Filler | Polyethylene compound (diameter 0.5 mm) | | | | | No |
| Airtight part forming method | During | During | During | During | Before | |
| (filler heat timing) | cross-link | cross-link | cross-link | cross-link | extrusion | |
| Compression into stranded | Yes | No | Yes | No | No | |
| conductors | | | | | | |
| Expansion component | Yes | Yes | No | No | No | |
| Stranded conductors diameter | 1.05 mm | | | | | 0.9 mm |
| Insulation | Polyfluorocarbon rubber compound | | | | | |
| Finished outer diameter | 2.1 mm | | | | | 1.7 mm |
| Airtight performance | 0 | 2 | 1 | 10 | 10 | 40 |
| (air leakage amount: ml) | | | | | | |
| Oil leakage | 0 | 0 | 0 | 0.5 | 0.5 | 3 |
| (oil leakage amount: g) | | | | | | |
| Terminal processability | ⊚ | ◯ | ⊚ | ◯ | ◯ | ◯ |
| (remaining insulation material | | | | | | |
| on conductor) | | | | | | |

TABLE 2

| | | Ex- | Ex- | Comparative | Comparative | Comparative | Comparative | Comparative |
|---|---|---|---|---|---|---|---|---|
| Example | Example | ample | ample | example | example | example | example | example |
| 2-1 | 2-2 | 2-3 | 2-4 | 2-1 | 2-2 | 2-3 | 2-4 | 2-5 |

| Conductor wires | | TA 11/0.26, with center filler | | | | TA 20/0.18 |
|---|---|---|---|---|---|---|
| Filler | Airtight | Polyethylene | Polyfluorocarbon | Polyethylene compound | Polyfluorocarbon rubber | No |
| | material | compound | rubber compound | | compound | |

| | | |
|---|---|---|
| Core material | TA 1/0.26 | No |

| Compression into | Yes | No | Yes | No | Yes | No | Yes | No | No |
|---|---|---|---|---|---|---|---|---|---|
| stranded conductors | | | | | | | | | |
| Stranded conductors | 1.05 mm | | | | | | | | 0.9 mm |
| diameter | | | | | | | | | |
| Insulation | Polyethylene | | Polyfluorocarbon | | Polyethylene compound | | Polyfluorocarbon rubber compound | | |
| | | | compound | | rubber compound | | | | |
| Finished outer | 1.7 mm | | | | | | | | |
| diameter | | | | | | | | | |
| Airtight performance | 0 | 2 | 0 | 1 | 0 | 2 | 0 | 2 | 40 |
| (air leakage amount | | | | | | | | | |
| ml) | | | | | | | | | |
| Oil leakage | 0 | 0 | 0 | 0 | 0 | 0 | 0 | 0 | 3 |
| (oil leakage amount: g) | | | | | | | | | |
| Terminal | ⊚ | ◯ | ⊚ | ◯ | ⊚ | ◯ | ⊚ | ◯ | ◯ |
| processability | | | | | | | | | |
| (remaining insulation | | | | | | | | | |
| material on conductor) | | | | | | | | | |
| Productivity | 200 | 200 | 150 | 150 | 20 | 20 | 10 | 10 | — |
| (line speed: m/mim) | | | | | | | | | |

TABLE 3

| Example | Example | Example | Example | Example | Example | Example | Example |
|---|---|---|---|---|---|---|---|
| 3-1 | 3-2 | 3-3 | 3-4 | 3-5 | 3-6 | 3-7 | 3-8 |

| Conductor wires | | TA 11/0.26, with center filler | |
|---|---|---|---|
| Filler | Airtight | Polyethylene compound + Polyalkylene | |
| | material | oxide resin | |
| | Core material | TA 1/0.26 | No |

| Compression into | Yes | No | Yes | No | Yes | No | Yes | No |
|---|---|---|---|---|---|---|---|---|
| stranded conductors | | | | | | | | |
| Stranded conductors | 1.05 mm | | | | | | | |
| diameter | | | | | | | | |
| Insulation | Polyethylene compound | | | | | | | |
| Finished outer diameter | 1.7 mm | | | | | | | |
| Swelling volume | 3 | 5 | 10 | 15 | 20 | 10 | 10 | 10 |
| (outer diameter increase | | | | | | | | |
| rate: %) | | | | | | | | |
| Water leakage | 0.5 | 0 | 0 | 0 | 0 | 0.2 | 0 | 0.2 |
| (water leakage amount: | | | | | | | | |
| ml) | | | | | | | | |
| Airtight performance | 0.5 | 0 | 0 | 0 | 2.0 | 1.0 | 0 | 1.0 |
| (air leakage amount: | | | | | | | | |
| ml) | | | | | | | | |
| Terminal processability | ⊚ | ⊚ | ⊚ | ⊚ | ⊚ | ◯ | ⊚ | ◯ |
| (remaining insulation | | | | | | | | |
| material on conductor) | | | | | | | | |
| Productivity | 200 | 200 | 200 | 200 | 200 | 200 | 20 | 20 |
| (line speed: m/mim) | | | | | | | | |

TABLE 4

| | | Example | Example | Example | Example | Example | Example |
|---|---|---|---|---|---|---|---|
| | | 3-9 | 3-10 | 3-11 | 3-12 | 3-13 | 3-14 |
| Conductor wires | | TA 11/0.26, with center filler | | | | | |
| Filler | Airtight | Liquid swellable | | Liquid swellable | | Liquid swellable | |
| | material | polyfluorocarbon | | polyfluorocarbon | | polyethylene | |
| | | rubber compound + | | rubber compound | | compound | |
| | | Polyalkylene oxide | | | | | |
| | | resin | | | | | |
| | Core material | TA 1/0.26 | No | TA 1/0.26 | No | TA 1/0.26 | No |

| Compression into | Yes | | | | | |
|---|---|---|---|---|---|---|
| stranded conductors | | | | | | |
| Stranded conductors | 1.05 mm | | | | | |
| diameter | | | | | | |
| Insulation | Polyfluorocarbon rubber compound | | | | | |
| Finished outer diameter | 2.0 mm | | | | | |
| Swelling volume | 10 | 10 | 10 | 10 | 5 | 5 |
| (outer diameter increase | | | | | | |
| rate: %) | | | | | | |
| Water leakage | 0 | 0 | — | — | — | — |
| (water leakage amount: | | | | | | |
| ml) | | | | | | |
| Airtight performance | 0 | 0 | 0 | 0 | 0.1 | 0.1 |
| (air leakage amount: ml) | | | | | | |
| Oil leakage | 0 | 0 | 0 | 0 | 0 | 0 |
| (oil leakage amount: g) | | | | | | |
| Terminal processability | ⊚ | ⊚ | ⊚ | ⊚ | ⊚ | ◯ |
| (remaining insulation | | | | | | |
| material on conductor) | | | | | | |
| Productivity | 150 | 10 | 150 | 10 | 200 | 20 |
| (line speed: m/mim) | | | | | | |

TABLE 5

| Comparative | Comparative | Comparative | Comparative | Comparative |
|---|---|---|---|---|
| example | example | example | example | example |
| 3-1 | 3-2 | 3-3 | 3-4 | 3-5 |

| Conductor wires | | TA 11/0.26, with center filler | TA 20/0.18 |
|---|---|---|---|
| Filler | Airtight | Polyethylene compound | No |
| | material | | |

| | | |
|---|---|---|
| Core material | TA 1/0.26 | No |

| Compression into | Yes | No | Yes | No | |
|---|---|---|---|---|---|
| stranded conductors | | | | | |
| Stranded conductors | 1.05 mm | | | | 0.9 mm |
| diameter | | | | | |
| Insulation | Polyethylene compound | | | | |
| Finished outer diameter | 1.7 mm | | | | |
| Swelling volume | 0 | 0 | 0 | 0 | — |
| (outer diameter increase | | | | | |
| rate: %) | | | | | |
| Water leakage | 1.0 | 2.2 | 1.1 | 2.2 | 50 |
| (water leakage amount: | | | | | |
| ml) | | | | | |
| Airtight performance | 1.0 | 2.0 | 1.0 | 2.0 | 40 |
| (air leakage amount: ml) | | | | | |
| Terminal processability | ⊚ | ◯ | ⊚ | ◯ | ◯ |
| (remaining insulation | | | | | |
| material on conductor) | | | | | |
| Productivity | 200 | 200 | 20 | 20 | — |
| (line speed: m/mim) | | | | | |

1. An airtight cable essentially provided with a plurality of conductor wires and a filler, comprising stranded conductors in which an airtight part has been formed, at least partially, in the elongating direction, and an insulation covering on an outer periphery of said stranded conductors, characterized in that:
said filler is composed, at least, of an airtight material comprising a thermoplastic polymer;
said conductor wires are positioned at an outermost layer of said stranded conductors; and
said airtight material serving as said filler is intruding into the space between respective conductor wires in said airtight part of said stranded conductors.

2. An airtight cable essentially provided with a plurality of conductor wires and a filler, comprising stranded conductors in which an airtight part has been formed, at least partially, in the elongating direction, and an insulation covering on an outer periphery of said stranded conductors, characterized in that:
said filler is composed, at least, of an airtight material, comprising a core material, and a thermoplastic polymer or a thermosetting polymer covering on an outer periphery of said core material;
said conductor wires are positioned at an outermost layer of said stranded conductors; and
said airtight material serving as said filler is intruding into the space between respective conductor wires in said airtight part of said stranded conductors.

3. An airtight cable essentially provided with a plurality of conductor wires and a filler, comprising stranded conductors in which an airtight part has been formed, at least partially, in the elongating direction, and an insulation covering on an outer periphery of said stranded conductors, characterized in that:
said filler is composed, at least, of an airtight material comprising a liquid swellable material;
said conductor wires are positioned at an outermost layer of said stranded conductors; and
said airtight material serving as said filler is intruding into the space between respective conductor wires in said airtight part of said stranded conductors.

4. An airtight cable essentially provided with a plurality of conductor wires and a filler, comprising stranded conductors in which an airtight part has been formed, at least partially, in the elongating direction, and an insulation covering on an outer periphery of said stranded conductors, characterized in that;
said filler is composed, at least, of an airtight material, comprising a core material, and a liquid swellable material covering on an outer periphery of said core material;
said conductor wires are positioned at an outermost layer of said stranded conductors; and
said airtight material serving as said filler is intruding into the space between respective conductor wires in said airtight part of said stranded conductors.

5. The airtight cable as claimed in claim 3 or claim 4, further characterized in that:
said airtight material comprising said liquid swellable material, is at least comprising a liquid swellable polymer, or is at least comprising a liquid swellable polymer blended with a thermoplastic polymer or with a thermosetting polymer.

6. The airtight cable as claimed in any one claim of claims 3 through 5, further characterized in that:
the swelling volume of the outer diameter of said filler, when said liquid swellable material absorbs liquid, is not less than 5% and not more than 15%.

7. The airtight cable as claimed in any one claim of claims 3 through 6, further characterized in that:
a polyalkylene oxide resin is used as said liquid swellable polymer.

8. The airtight cable as claimed in any one claim of claims 1 through 7, further characterized in that:
said conductor wires positioned at the outermost layer of said stranded conductors have been compressed in the radial direction so that said conductor wires may be in contact tightly with each other.

9. A manufacturing method of airtight cable comprising steps of:
forming stranded conductors by stranding a plurality of conductor wires and a filler so that said conductor wires may be positioned at an outermost layer of said stranded conductors; and
forming an airtight part, during extruding of and covering with an insulation, or after extruding of and covering with an insulation, on an outer periphery of said stranded conductors.

10. The manufacturing method of airtight cable as claimed in claim 9, further comprising a step of:
forming said airtight part through heat processing of said filler by using heat generated during extruding of and covering with said insulation.

11. The manufacturing method of airtight cable as claimed in claim 9, further comprising a step of:
forming said airtight part through heat processing of said filler by using heat generated during application of heat and cross-linking to said insulation.

12. The manufacturing method of airtight cable as claimed in claim 9, further comprising a step of:
compressing said stranded conductors before extruding of and covering with said insulation on the outer periphery of said stranded conductors.

13. The manufacturing method of airtight cable as claimed in claim 9, further comprising a step of:
using said filler by extruding of and covering on with an airtight material on an outer periphery of a core material.
